(19) United States
(12) Patent Application Publication
(10) Pub. No.: US 2011/0066092 A1
(43) Pub. Date: Mar. 17, 2011

(54) PERFUSION REGULATION DEVICE

(75) Inventors: Bastiaan Wilhelmus Maria Moeskops, Eindhoven (NL); Yan Liu, Eindhoven (NL); Kiran Kumar Thumma, Eindhoven (NL); Golo Von Basum, Eindhoven (NL)

(73) Assignee: KONINKLIJKE PHILIPS ELECTRONICS N.V., EINDHOVEN (NL)

(21) Appl. No.: 12/992,605

(22) PCT Filed: May 12, 2009
(86) PCT No.: PCT/IB2009/051948

§ 371 Date: Nov. 15, 2010

(30) Foreign Application Priority Data
May 19, 2008 (EP) 08156433.8

(51) Int. Cl. A61H 9/00; B23P 17/04

(52) U.S. Cl. 601/134; 29/428

(57) ABSTRACT

A perfusion, regulation device (10) for regulating tissue perfusion at a target site (2) on a human or animal body. The perfusion regulation device (10) comprises a pressure regulator (4) for determining and regulating pressure exerted by the perfusion regulation device (10) on the target site (2) and a perfusion monitor (5) for measuring tissue perfusion at the target site (2). The perfusion regulation device (10) furthermore comprises a control system (6) for driving the pressure regulator (4) so as to regulate pressure exerted by the perfusion regulation device (10) to the target site (2) thereby using feedback from the perfusion monitor (5). There is also a method for making such a perfusion regulation device (10) and a method for regulating tissue perfusion at a target site (2) on a human or animal body using such a perfusion regulation device (10).

### TECHNICAL FIELD OF THE INVENTION

The present invention relates to measurement and/or treatment devices, e.g. non-invasive measurement and/or treatment devices. More particularly, the present invention relates to a perfusion regulation device for regulating tissue perfusion at a target site on a human or animal body, a method for making such a perfusion regulation device and a method for regulating tissue perfusion at a target site on a human or animal body.

### BACKGROUND OF THE INVENTION

Obtaining values for biological or physical quantities in a living body in a non-invasive way has been thoroughly studied over the last few decades. Obtaining accurately reproducible results by using sophisticated sensing and actuating devices for medical purposes may become difficult when sensors have to be repeatedly removed and replaced.

Currently, many efforts have been put in developing instruments for non-invasive measurement of physiological parameters in a human or animal body, such as for example glucose measurements, based on optical methods. Although these methods have proven to have sufficient sensitivity for in-vitro and/or ex-vivo glucose quantification, devices based on such currently existing techniques have not been successfully brought to the market. The main reason is that the accuracy of recently developed devices is not sufficient to get an FDA (food and drug administration) approval.

Also instruments have been developed for minimally invasive measurement of physiological parameters in a human or animal body, such as for example glucose measurements, e.g. based on optical methods. These methods make use of a sensor implanted beneath the skin which is in contact with subcutaneous fluids. The sensor may include gels, particles, liquids which are biodegradable. Preferably, the biosensor that has to be implanted is small in size, and does not require a complicated or painful insertion below the skin.

Nevertheless, performing a non-invasive measurement is the most desirable method for consumers. But the uncertainty and inaccuracy hampered the acceptance of non-invasive tests. There is a strong need in the non-invasive glucose-monitoring market to solve the inaccuracy or unreliability problems.

Many techniques have been investigated to non-invasively detect skin analyte(s) concentration by means of optical, electrical and/or optoelectronic methods, such as for example non-invasive glucose monitoring. Typically, in vivo measurements deal with a larger number of chemical, physical, and physiological interfering elements compared to in vitro measurements. These interfering elements induce irreproducibility and inaccuracy of non-invasive measurements. Information on the presence of interfering elements, their effects, and variability range are often not known. Typically, data analysis of a system where a number of interfering elements is present is based on chemometric tools, e.g. multivariate analysis. However, for complex and variable systems such as e.g. human tissue, chemometric analysis becomes more complicated and may be prone to large errors. The accuracy and reproducibility of these measurements are generally poor due to the many interfering elements and the irreproducibility compared with the in vitro case.

An example of such an irreproducible factor is skin perfusion, also referred to as blood perfusion. Its variation may significantly influence optical and/or electrical signals. To stabilize the signals and minimize the variation, blood perfusion should be controlled as well as possible during non-invasive measurements. Another irreproducible factor is the relative position of the sensing device to an implanted minimally invasive biosensor.

A factor that may strongly influence skin perfusion is pressure. Any contact-dependent non-invasive probe device has, for performing measurement, to make contact with the skin. Thereby, the probe device which is used to perform the measurement will exert a pressure on the skin. This exerted pressure will change the skin perfusion. More particularly, it is known that variations in the force exerted by a probe device on the skin causes errors in the results of spectroscopic sensing techniques performed by the probe device. To increase accuracy of such contact-dependent techniques the contact between the skin and the probe device should be kept constant and reproducible.

Near infrared spectroscopy of skin is a promising method to, for example, non-invasively measure a person's glucose level. When using a contract probe in order to maximize light coupling to the skin, the resulting force applied to the skin may change the optical properties of the skin.

Different approaches exist to overcome this problem.

One approach may be by carefully controlling the load of the probe device or by distributing it over a large skin surface. This may, for example, be done by using a probe placement guide (including a patch) to help control force exerted on the skin (see US 2003/0069484).

Because of the dependency of the optical properties of the skin on the force exerted by the probe device, it is difficult to realize reproducible measurements.

Other approaches such as, for example, measuring or evaluating perfusion rate, the use of a blood perfusion enhancer together with a skin-surface sensor for improving the measurement or the use of over-systolic pressure to stop blood flow at the measuring location are described in literature.

However, it may still be discussed whether the problem of the influence of blood perfusion on the non-invasive measurement is solved by using the above techniques. A problem that still may exist is how to attach the probe device to the skin so that it exerts a constant force on the skin after being attached and how to obtain reproducible results.

### SUMMARY OF THE INVENTION

It is an object of embodiments of the present invention to provide a perfusion regulation device for regulating tissue perfusion at a target site on a human or animal body, a method for making such a perfusion regulation device and a method for regulating tissue perfusion at a target site on a human or animal body.

The above objective is accomplished by a method and device according to the present invention.

By tightly controlling the pressure applied on the skin, changes in perfusion and thereby also changes in optical properties of the skin can be minimized. This may lead to good accuracy and reproducibility of subsequent measurements of physiological parameters, e.g. minimally invasive or non-invasive measurements, and/or subsequent treatments of the human or animal body.

The perfusion regulation device and methods according to embodiments of the invention may be used with any known technique for measuring a physiological parameter in a human or animal body at a target site. For example, the perfusion regulation device and methods according to embodiments of the invention may be used for minimally invasive or non-invasive glucose detection by optical means such as NIR (near infrared) diffuse back-reflectance spectroscopy. For example, the perfusion regulation device and methods according to embodiments of the invention may be used for minimally invasive or non-invasive glucose detection by means near-infrared spectroscopy, based on a change in the concentration of glucose being indicated by a change in the absorption of light according to the absorption and scattering properties of glucose and/or the effect of glucose changes upon the anatomy and physiology of the sampled site. The measurement of glucose through spectroscopy can also be made by a change in the absorption of light according to the absorption and scattering properties of minimally invasive microsensors, or to the change in light emitted or reflected from such microsensors located below the skin. Such methods using microsensors may include, for example,

observing fluorescence (e.g. fluorescence resonance energy transfer) of a competitive binding assay encapsulated in microcapsules, for example based on competitive binding between the protein Concanavalin A and various saccharide molecules, specifically a glycodendrimer and glucose, the microcapsules can be polyelectrolyte microcapsules,

detecting glucose using boronic acid-substituted violegens in fluorescent hydrogels in which a fluorescent anionic dye and a viologen are appended to boronic acid, which serve as glucose receptors, and are immobilized into a hydrogel, the fluorescence of the dye being modulated by the quenching efficiency of the viologen based receptor which is dependent upon the glucose concentration,

other methods, e.g. to monitor oxygen or pH or other “smart tattoo” methods.

Further applications may be measurements of skin properties such as e.g. skin cancer or skin aging, by means of light. The perfusion regulation device and methods according to embodiments of the invention may also be used with any known treatment technique for treatment of a human or animal body, such as e.g. treatment by heat or light for hair removal or treatments for skin disorder or skin aging.

In a first aspect, the present invention provides a perfusion regulation device for regulating tissue perfusion at a target site on a human or animal body. The perfusion regulation device comprises:

a pressure regulator for determining and regulating pressure exerted by the perfusion regulation device on the target site,

a tissue perfusion monitor for measuring tissue perfusion at the target site, and

a control system for generating an error signal based on a difference between the measured tissue perfusion and a reference setpoint value and for driving the pressure regulator so as to regulate pressure exerted by the perfusion regulation device to the target site based on the error signal.

With tissue perfusion is meant perfusion of a body fluid such as blood or interstitial fluid in tissue, such as skin, or an organ of a human or animal body. In case of blood flowing through tissue or an organ, the perfusion is especially by way of the blood vessels.

By tightly controlling the pressure applied on the skin, changes in tissue perfusion and thereby also changes in optical properties of the skin can be minimized. This may lead to good accuracy and reproducibility of subsequent measurements of physiological parameters, e.g. non-invasive measurements, and/or subsequent treatment of the human or animal body.

According to embodiments of the invention, the perfusion regulation device may furthermore comprise a sensing and/or treatment element for directly or indirectly sensing analytes in a body fluid in the human or animal body so as to determine the physiological parameter and/or to perform treatment of the human or animal body.

The perfusion regulation device may furthermore comprise a mounting system for attaching the perfusion regulation device to the human or animal body at the target site. In that case, the perfusion regulation device does not have to be held by a user, e.g. patient, nurse or doctor.

According to embodiments of the invention, the mounting system may comprise a constraint such as a strap e.g. an elastic band for surrounding a part of the human or animal body on which the target site is located.

According to embodiments of the invention, the pressure regulator may comprise a mechanical pressure actuator and sensor. The mechanical pressure actuator and sensor may, for example, comprise at least one piezoelectric element.

The perfusion monitor may be a Laser Doppler device. In that case, Laser Doppler flowmetry is used to measure tissue perfusion.

According to embodiments of the invention, the sensing and/or treatment element may be a spectroscopic sensor.

In a further aspect, the present invention provides the use of a perfusion regulation device according to embodiments of the present invention for performing minimally invasive or non-invasive glucose detection in blood of a human or animal.

In another aspect, the present invention also provides a method for making a perfusion regulation device for regulating tissue perfusion at a target site on a human or animal body. The method comprises:

providing a pressure regulator adapted for determining and regulating pressure exerted by the perfusion regulation device on a target site of the human or animal body,

providing a perfusion monitor adapted for measuring tissue perfusion at the target site, and

providing a controller adapted for generating an error signal based on a difference between the measured tissue perfusion and a reference setpoint value and for driving the pressure regulator so as to regulate pressure exerted by the perfusion regulation device to the target site based on the error signal.

According to embodiments of the invention, the method may furthermore comprise providing a sensing and/or treatment element adapted for sensing analytes in a body fluid in the human or animal body at the target site so as to determine the physiological parameter and/or to perform treatment of the human or animal body.

The method may furthermore comprise providing a mounting system for attaching the perfusion regulation device to the human or animal body at the target site.

In yet a further aspect, the present invention provides a perfusion regulation device made by a method according to embodiments of the present invention.

In still a further aspect, the invention provides a method for regulating tissue perfusion at a target site on a human or animal body. The method comprises:

a) determining pressure exerted by a perfusion regulation device on the target site,
b) measuring tissue perfusion at the target site,
c) comparing the measured tissue perfusion to a reference setpoint value, and
d) regulating pressure exerted by the perfusion regulation device to the target site based on a difference between the measured tissue perfusion and the reference setpoint value.

According to embodiments of the invention, the method may furthermore comprise measuring a physiological parameter in the human or animal body.

According to embodiments of the invention, the method may furthermore comprise performing treatment of the human or animal body.

The method may furthermore comprise, before determining pressure exerted by the perfusion regulation device, attaching the perfusion regulation device to the human or animal body at the target site. This may be done by, for example, using a constraint such as a strap e.g. an elastic band for surrounding a part of the human or animal body on which the target site is located.

According to embodiments of the invention, regulating the pressure exerted by the perfusion regulation device to the target site may be performed such that tissue perfusion at the location of the target site is kept constant.

According to other embodiments of the invention, regulating the pressure exerted by the perfusion regulation device to the target site may be performed such that tissue perfusion is controllably varied in time during measurement of the physiological parameter in and/or treatment of the human or animal body.

The method may furthermore comprise repeating steps a) to d) at least once.

In still a further aspect, the invention provides a controller for controlled driving of a pressure regulator of a perfusion regulation device. The controller comprises a control unit for controlling the pressure regulator thereby using an error signal generated based on a difference between a measured tissue perfusion and a reference setpoint.

In still a further aspect, the present invention also provides a computer program product for performing, when executed on a computing means, a method according to embodiments of the invention.

In still a further aspect, the present invention also provides a machine readable data storage device storing a computer program product according to embodiments of the invention.

In still a further aspect, the present invention also provides transmission of a computer program product according to embodiments of the invention over a local or wide area telecommunications network.

Particular and preferred aspects of the invention are set out in the accompanying independent and dependent claims. Features from the dependent claims may be combined with features of the independent claims and with features of other dependent claims as appropriate and not merely as explicitly set out in the claims.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1 schematically illustrates a perfusion regulation device according to an embodiment of the present invention.

FIG. 2 illustrates an embodiment of an algorithm which may be used with embodiments of the present invention.

FIG. 3 illustrates a flow chart of a method according to an embodiment of the present invention.

FIG. 4 schematically illustrates a system controller for use with a perfusion regulation device according to embodiments of the present invention.

FIG. 5 is a schematic representation of a processing system as can be used for performing a method according to embodiments of the present invention.

In the different figures, the same reference signs refer to the same or analogous elements.

### DESCRIPTION OF ILLUSTRATIVE EMBODIMENTS

The present invention will be described with respect to particular embodiments and with reference to certain drawings but the invention is not limited thereto but only by the claims. Any reference signs in the claims shall not be construed as limiting the scope. The drawings described are only schematic and are non-limiting. In the drawings, the size of some of the elements may be exaggerated and not drawn on scale for illustrative purposes.

Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

The present invention relates to measurement devices and more particularly to minimally invasive or non-invasive measurement devices. The term “minimally invasive” as used for example in the phrase minimally invasive measurement of physiological parameters in a human or animal body, includes those methods where there is a minor level of invasion. An example is where the measurement itself is non-invasive but the determination of the analyte is done with the help of an implanted microsensor, e.g. a subcutaneous microsensor. The sensor is implanted beneath the skin which is in contact with subcutaneous fluids. The sensor may include gels, particles, liquids which are biodegradable. Preferably, the biosensor that has to be implanted is small in size, and does not require a complicated or painful insertion below the skin. The microsensor comprises an assay such as for example for the determination of glucose, e.g. based on optical methods.

The present invention provides a perfusion regulation device for regulating tissue perfusion at a target site on a human or animal body, a method for making such a perfusion regulation device and a method for regulating tissue perfusion at a target site on a human or animal body.

The physiological parameter may, for example, be any physiological parameter to be determined in a body fluid such as blood or an interstitial fluid (also referred to as tissue fluid or intercellular fluid). For example, the physiological parameter may be related to the presence and/or concentration of an analyte present in a body fluid such as blood or an interstitial fluid. The analyte may be any analyte of which it is important to detect its presence and/or to determine its concentration in the body fluid. An example hereof is the concentration of glucose in the blood of a human being. The analyte can be any organic molecule which is present in a human or animal body such as, for example, cholesterol, haemoglobin, acetone, water, lactic acid or melanin, or can be any inorganic molecule in a human or animal body such as, for example, iron or calcium, or can be another feature such as, for example the presence and/or concentration of gases or pH. The physiological parameter may, for example, be any physiological parameter to be determined in a body fluid such as blood or an interstitial fluid (also referred to as tissue fluid or intercellular fluid) by use of a subcutaneous microsensor.

Embodiments of the present invention can be generally applied to any sensing method or treatment method, or a combination of both, in which tissue perfusion at a target location on skin of the human or animal body plays an important role. Examples of such sensing methods may, for example, be ultrasound, temperature sensing, pressure sensing, measurements using parts of the electromagnetic spectrum (such as optical, microwave or radiowave methods), skin impedance and capacitance measurements, and measurements of flux of compounds (such as TransEpidermal Water Loss). Examples of such treatment methods may, for example, be any treatment method to be applied to skin of a human or animal body, such as treatment by heat or light for hair removal, treatments for skin disorder or skin aging, any treating method to be applied through skin of a human or animal body, such as medication injection or transdermal drug delivery or any method to be applied into skin, such as using catheter ablation or taking biopsy.

According to other embodiments of the invention, the physiological parameter may also be a parameter suitable for determining skin properties such as e.g. skin cancer or skin aging. In such cases, the parameter may, for example, be reflectivity, evenness, temperature, temperature difference, color, color differences, stains.

As an example, parameters for determining skin properties such as skin cancer and skin aging could be optical properties of the skin. These may, among others, comprise performing measurements of absorption, scattering, reflection or birefringence at one or more wavelengths.

The perfusion regulation device and methods according to embodiments of the invention may be used with any known technique for measuring a physiological parameter in a human or animal body at a target site. For example, the perfusion regulation device and methods according to embodiments of the invention may be used for minimally invasive or non-invasive glucose detection by means of NIR (near infrared) diffuse back-reflectance spectroscopy. Further applications may be measurements of skin properties such as e.g. skin cancer or skin aging, by means of light.

In a first aspect, the present invention provides a perfusion regulation device for regulating tissue perfusion at a target site on a human or animal body. The perfusion regulation device comprises:

a pressure regulator for determining and regulating pressure exerted by the perfusion regulation device onto the target site,

a perfusion monitor for measuring tissue perfusion at the target site, and

a control system for generating an error signal based on a difference between the measured tissue perfusion and a reference setpoint value and for driving the pressure regulator so as to regulate pressure exerted by the perfusion regulation device to the target site based on the error signal.

According to embodiments of the invention, the perfusion regulation device may furthermore comprise a sensing and/or treatment element (7) for sensing analytes in a body fluid in the human or animal body so as to determine the physiological parameter and/or for performing treatment of the human or animal body.

By tightly controlling the pressure applied on the skin, changes in tissue perfusion and thereby also changes in optical properties of the skin can be minimized. This may lead to good accuracy and reproducibility of subsequent measurements of physiological parameters, e.g. non-invasive measurements, in and/or treatments of the human or animal body.

With tissue perfusion is meant perfusion of a body fluid such as blood or interstitial fluid in tissue, such as skin, or an organ of a human or animal body. In case of blood flowing through tissue or an organ, the perfusion is especially by way of the blood vessels. Therefore, tissue perfusion may, according to one embodiment, also be referred to as blood perfusion. In embodiments of the present invention the tissue perfusion may for example be skin perfusion.

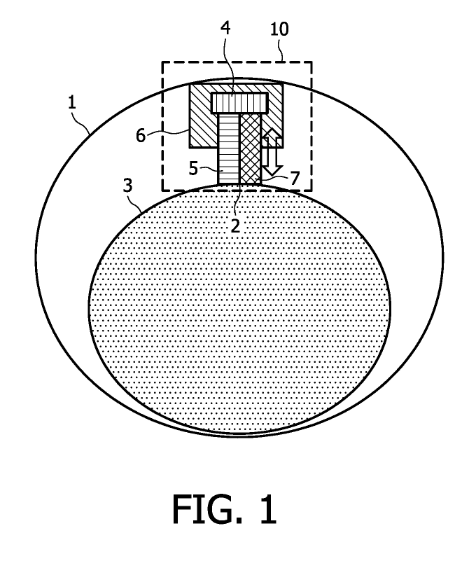

FIG. 1 illustrates a perfusion regulation device 10 according to an embodiment of the present invention. The perfusion regulation device 10 may comprise a mounting system 1 for attaching the perfusion regulation device 10 to the human or animal body at a target site 2 on a part 3 of the human or animal body, e.g. an arm of a human being. With target site 2 is meant the location at the body part 3 of the human being or animal at which measurement of a physiological parameter and/or treatment has to be performed. According to embodiments of the invention, the mounting system 1 may comprise a constraint such as a strap e.g. an elastic band as illustrated in FIG. 1. By attaching the perfusion regulation device 10 to the target site 2, in the example given by means of the elastic band 1, the perfusion regulation device 10 will exert a certain pressure to the target site 2. Because of this pressure, there may be irregularities in the tissue perfusion at the target site 2. These irregularities in tissue perfusion may, for example, hamper subsequent measurement of the physiological parameter in the body fluid. Therefore, the perfusion regulation device 10 comprises a pressure regulator 4 for determining and regulating the pressure exerted by the perfusion regulation device 10 on the target site 2. The pressure regulator 4 may, according to embodiments of the invention, comprise a pressure actuator and sensor. The pressure actuator and sensor may, for example, comprise at least one piezoelectric element to sense and regulate the pressure. The pressure regulator 4 varies the force between the perfusion regulation device 10 and the target site 2 or, in other words, the pressure regulator 4 regulates the pressure exerted by the perfusion regulation device 10 to the target site 2, thereby using feedback from a perfusion monitor (see further). According to embodiments of the invention, regulation of the pressure exerted by the perfusion regulation device 10 to the target site 2 may be such that tissue perfusion at the location of the target site 2 is kept substantially constant, meaning that tissue perfusion at the location of the target site 2 is kept at a pre-determined target level. This pre-determined target level can be the perfusion level achieved during an initial measurement performed by a user. It can also be a factory-set target level. If the pre-determined target level cannot be achieved within the limits of the device, e.g. maximum and minimum force that can be applied, then a new target level may be defined within the achievable pressure range and thus within the achievable perfusion range.

According to other embodiments of the invention, regulation of the pressure exerted by the perfusion regulation device 10 to the target site 2 may be such that tissue perfusion is controllably varied in time. For example, regulation of the pressure exerted by the perfusion regulation device 10 may be such that tissue perfusion is gradually increased or decreased. This may, according to embodiments of the present invention, be done before measurement of the physiological parameter and/or treatment of the human or animal body and/or during performance of the measurement of the physiological parameter and/or treatment of the human or animal body. In this case, measurements and/or treatments can continuously be performed during a controlled change in tissue perfusion. Alternatively, measurements and/or treatments can be performed at a limited number of time points during or after a perfusion-change cycle, e.g. before and after perfusion change.

The perfusion regulation device 10 furthermore comprises a tissue perfusion monitor 5 for measuring tissue perfusion at the target site 2. According to embodiments of the invention, the tissue perfusion monitor 5 may, for example be, a Laser Doppler device. In that case, Laser Doppler flowmetry is used to measure tissue perfusion. This technique is based on the values of the Doppler effect of low-power laser light randomly scattered by static structures, such as e.g. a vein or tissue, and moving body fluid particulates such as blood particulates or tissue particulates. According to other embodiments, the perfusion monitor 5 may be a temperature monitor or any other means for measuring tissue perfusion known by a person skilled in the art.

The perfusion regulation device 10 furthermore comprises a controller 6 for driving the pressure regulator 4, e.g. pressure actuator and sensor so as to regulate the pressure exerted by the perfusion regulation device 10 onto the target site 2. The controller 6 uses an output from the tissue perfusion monitor 5 as a basis for an input to the pressure regulator 4. In other words, the controller 6 drives the pressure regulator 4 by using feedback from the tissue perfusion monitor 5. According to embodiments of the invention, controlling may be done such that the pressure is regulated so as to keep tissue perfusion substantially constant. According to other embodiments of the invention, controlling may be done such the pressure is regulated so as to controllably vary tissue perfusion in time.

The controller 6 may comprise electronics and logic in the form of an algorithm. The algorithm may, for example, be similar to algorithms used in PID (proportional-integral-derivative) controllers (temperature regulators). However, also other means of calculating the pressure adjustment may be used with embodiments of the present invention. For example, other control loop methods that can be used for calculating the pressure adjustment may be, among others, Logic control, On-off control, Linear control, Proportional control or Fuzzy logic.

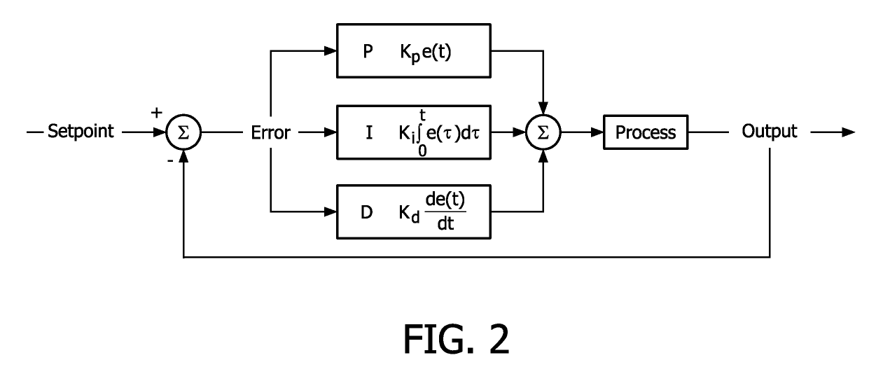

FIG. 2 illustrates an embodiment of an algorithm that may be used with embodiments of the present invention. The controller 6 uses a measured value for tissue perfusion at the target site 2 and compares it with a reference setpoint value (see further). The difference between the measured value and the reference setpoint value, also referred to as error signal, is then used to drive the pressure regulator 4 so as to adjust the pressure exerted by the perfusion regulation device 10 to the target site 2. In that way, a new, updated pressure is determined based on the measured pressure, the current perfusion and the target perfusion or reference set point value. The algorithm should take the inertia of the system into account. For example, tissue and blood will not react instantaneously to changes in pressure. This creates the need to limit the rate at which updates to the exerted pressure are made. Several parameters of the algorithm will determine the dynamics of perfusion regulation. These parameters can be fixed in the factory when manufacturing the perfusion regulation device 10 or they can be determined from a tissue characterization test sequence. In the case of a PID controller these parameters may be K-values as indicated in FIG. 2, (Kₚ, Kᵢ and K_{d}.

According to embodiments of the invention, the perfusion regulation device 10 may furthermore comprise a sensing and/or treatment element 7. The sensing and/or treatment element 7 may be for measuring a physiological parameter in and/or treatment of the human or animal body at the target site 2. The sensing and/or treatment element 7 may be any sensing and/or treatment element 7 suitable for sensing analytes in a body fluid in the human or animal body so as to determine the physiological parameter in a body fluid of a human being or animal and/or for performing treatment of the human or animal body. For example, the sensing and/or treatment element 7 may be a spectroscopic sensor for analysis of tissue or blood analytes. For example, the sensing and/or treatment element 7 may be a minimally invasive or a non-invasive blood glucose sensor.

In a second aspect, the present invention provides a method for regulating tissue perfusion at a target site 2 on a human or animal body. The method comprises:

determining pressure exerted by a perfusion regulation device 10 on the target site 2,

measuring tissue perfusion at the target site,

comparing the measured tissue perfusion to a reference setpoint value, and

regulating pressure exerted by the perfusion regulation device 10 on the target site 2 based on a difference between the measured tissue perfusion and the reference setpoint value.

According to embodiments of the invention, the method may furthermore comprise measuring a physiological parameter in and/or performing treatment of the human or animal body.

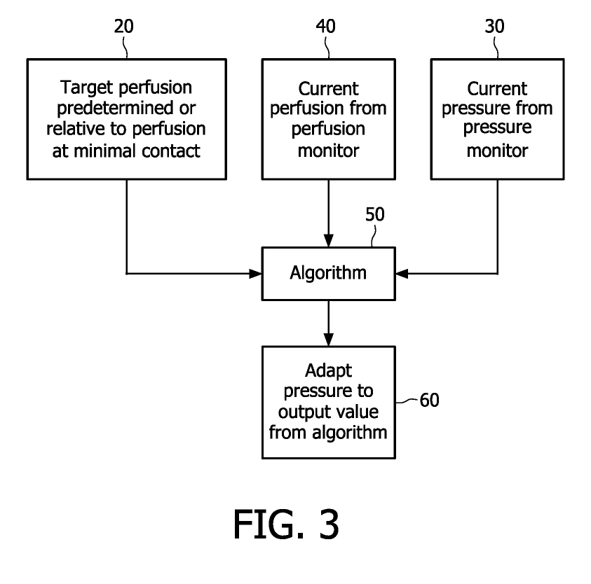

A method according to an embodiment of the present invention is illustrated in FIG. 3.

In a first step, a reference setpoint value, also referred to as target perfusion, may be obtained, e.g. determined (step 20). Determining the reference setpoint value may be done using an initial measurement on the user, for example by running a test sequence. This test sequence determines the maximum and minimal achievable perfusion at that time, by controlling the pressure. The target perfusion level for this and future measurements is then set within the achievable tissue perfusion range. For measurement of different analytes, a high tissue perfusion is preferred. However, by exerting pressure the tissue perfusion can only be decreased, not increased. Therefore, the desire for a high tissue perfusion, but also constant tissue perfusion every time, must be balanced. Furthermore, tissue perfusion may be, besides by pressure, also be influenced by many other factors. This means that the target perfusion level should be set significantly lower than the maximum observed perfusion during the test sequence, in order to allow matching this perfusion level also during subsequent measurements and/or treatments, when physiological and environmental conditions may have changed.

According to embodiments of the invention, the reference setpoint value may be a value determined in advance or may be a value related to perfusion at minimal contact, i.e. at minimum pressure exerted by the perfusion regulation device 10 to the target site 2.

The perfusion regulation device 10 may then be provided to the target site 2. According to embodiments of the present invention, a mounting system 1 may be used for attaching the perfusion regulation device 10 to the human or animal body at the target site 2. According to embodiments of the invention, the mounting system 1 may comprise a constraint, e.g. an elastic band for surrounding a part 3 of the human or animal body on which the target site 2 is located. After the perfusion regulation device 10 has been provided to the target site 2, the pressure exerted by the perfusion regulation device 10 to the target site 2 is measured by means of a pressure regulator 4 which may, for example, comprise a pressure actuator and sensor (step 30). According to embodiments of the invention, the pressure actuator and sensor may comprise at least one piezoelectric element. Also tissue perfusion is measured by means of a tissue perfusion monitor 5 (step 40).

From the values of the measured pressure, the measured perfusion and the reference setpoint value for the perfusion, by using an appropriate algorithm it may be determined how the pressure exerted by the perfusion regulation device 10 to the target site 2 has to be adapted in order to obtain a value for the tissue perfusion which is close or substantially equal to the reference setpoint value for the perfusion (step 50). An example of such an algorithm is illustrated in FIG. 2 and is described above.

In a last step, the pressure exerted by the perfusion regulation device 10 to the target site 2 is adapted based on a difference between the measured tissue perfusion and the reference setpoint value (step 60).

If necessary, i.e. when after adaptation of the pressure exerted by the perfusion regulation device 10 to the target site 2 the resulting value for the tissue perfusion is too far away from the reference setpoint value, e.g. differs more than a pre-determined threshold value, the above-described steps may be repeated as much as necessary.

When the measured tissue perfusion substantially equals the reference setpoint value, i.e. when the measured perfusion value is within, for example, 10%, e.g. within 1% or within 0.1% of the pre-determined threshold value, measurement of the physiological parameter in and/or treatment of the human or animal body is performed.

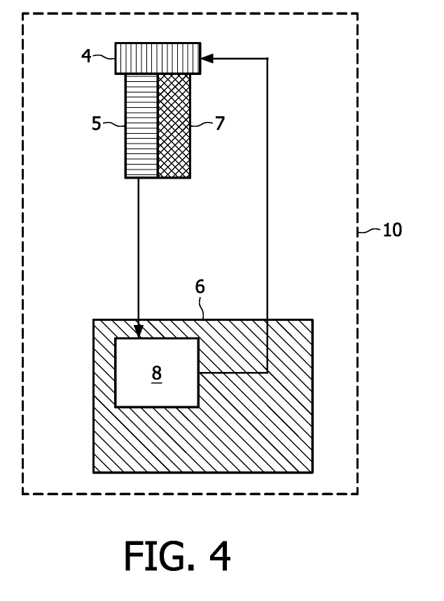

In a further aspect, the present invention also provides a system controller 6 for use in a perfusion regulation device 10 according to embodiments of the present invention for controlled driving of a pressure regulator 4 of the perfusion regulation device 10. The system controller 6, which is schematically illustrated in FIG. 4, may comprise a control unit 8 for controlling the pressure regulator 4 thereby using an error signal based on a difference between a measured tissue perfusion and a reference setpoint value.

The system controller 6 may include a computing device, e.g. microprocessor, for instance it may be a micro-controller. In particular, it may include a programmable controller, for instance a programmable digital logic device such as a Programmable Array Logic (PAL), a Programmable Logic Array, a Programmable Gate Array, especially a Field Programmable Gate Array (FPGA). The use of an FPGA allows subsequent programming of the perfusion regulation device 10, e.g. by downloading the required settings of the FPGA. The system controller 6 may be operated in accordance with settable parameters, such as driving parameters, for example temperature and timing parameters.

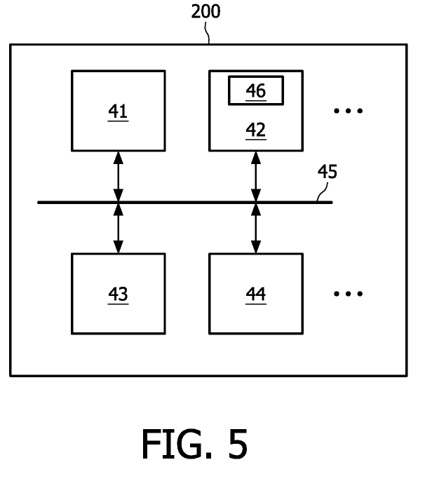

The method described above according to embodiments of the present invention may be implemented in a processing system 200 such as shown in FIG. 5. FIG. 5 shows one configuration of processing system 200 that includes at least one customizable or programmable processor 41 coupled to a memory subsystem 42 that includes at least one form of memory, e.g., RAM, ROM, and so forth. It is to be noted that the processor 41 or processors may be a general purpose, or a special purpose processor, and may be for inclusion in a device, e.g., a chip that has other components that perform other functions. Thus, one or more aspects of the method according to embodiments of the present invention can be implemented in digital electronic circuitry, or in computer hardware, firmware, software, or in combinations of them. The processing system may include a storage subsystem 43 that has at least one disk drive and/or CD-ROM drive and/or DVD drive. In some implementations, a display system, a keyboard, and a pointing device may be included as part of a user interface subsystem 44 to provide for a user to manually input information, such as parameter values. More elements such as network connections, interfaces to various devices, and so forth, may be included, but are not illustrated in FIG. 5. The various elements of the processing system 40 may be coupled in various ways, including via a bus subsystem 45 shown in FIG. 5 for simplicity as a single bus, but will be understood to those in the art to include a system of at least one bus. The memory of the memory subsystem 42 may at some time hold part or all (in either case shown as 46) of a set of instructions that when executed on the processing system 40 implement the steps of the method embodiments described herein.

The present invention also includes a computer program product which provides the functionality of any of the methods according to embodiments of the present invention when executed on a computing device. Such computer program product can be tangibly embodied in a carrier medium carrying machine-readable code for execution by a programmable processor. The present invention thus relates to a carrier medium carrying a computer program product that, when executed on computing means, provides instructions for executing any of the methods as described above. The term “carrier medium” refers to any medium that participates in providing instructions to a processor for execution. Such a medium may take many forms, including but not limited to, non-volatile media, and transmission media. Non-volatile media includes, for example, optical or magnetic disks, such as a storage device which is part of mass storage. Common forms of computer readable media include, a CD-ROM, a DVD, a flexible disk or floppy disk, a tape, a memory chip or cartridge or any other medium from which a computer can read. Various forms of computer readable media may be involved in carrying one or more sequences of one or more instructions to a processor for execution. The computer program product can also be transmitted via a carrier wave in a network, such as a LAN, a WAN or the Internet. Transmission media can take the form of acoustic or light waves, such as those generated during radio wave and infrared data communications. Transmission media include coaxial cables, copper wire and fibre optics, including the wires that comprise a bus within a computer.

It is to be understood that although preferred embodiments, specific constructions and configurations, as well as materials, have been discussed herein for devices according to the present invention, various changes or modifications in form and detail may be made without departing from the scope of this invention as defined by the appended claims.

1. A perfusion regulation device (10) for regulating tissue perfusion at a target site (2) on a human or animal body, the perfusion regulation device (10) comprising:
a pressure regulator (4) for determining and regulating pressure exerted by the perfusion regulation device (10) on the target site (2),
a perfusion monitor (5) for measuring tissue perfusion at the target site (2), and
a control system (6) for generating an error signal based on a difference between the measured tissue perfusion and a reference setpoint value and for driving the pressure regulator (4) so as to regulate pressure exerted by the perfusion regulation device (10) to the target site (2) based on the error signal.

2. Perfusion regulation device (10) according to claim 1, furthermore comprising a sensing and/or treatment element (7) for sensing analytes in a body fluid in the human or animal body so as to determine a physiological parameter and/or to perform treatment of the human or animal body.

3. Perfusion regulation device (10) according to claim 1, furthermore comprising a mounting system (1) for attaching the perfusion regulation device (10) to the human or animal body at the target site (2).

4. Perfusion regulation device (10) according to claim 3, wherein the mounting system (1) comprises a constraint for surrounding a part (3) of the human or animal body on which the target site (2) is located.

5. Perfusion regulation device (10) according to claim 1, wherein the pressure regulator (4) comprises a mechanical pressure actuator and sensor.

6. Perfusion regulation device (10) according to claim 1, wherein the perfusion monitor (5) is a Laser Doppler device.

7. Perfusion regulation device (10) according to claim 1, wherein said device is adapted to perform non-invasive glucose detection in blood of a human or animal.

8. Method for making a perfusion regulation device (10) for regulating tissue perfusion at a target site (2) on a human or animal body, the method comprising:
providing a pressure regulator (4) adapted for determining and regulating pressure exerted by the perfusion regulation device (10) at the target site (2) of the human or animal body,
providing a perfusion monitor (5) adapted for measuring tissue perfusion at the target site (2), and
providing a controller (6) adapted for generating an error signal based on a difference between the measured tissue perfusion and a reference setpoint value and for driving the pressure regulator (4) so as to regulate pressure exerted by the perfusion regulation device (10) to the target site (2) based on the error signal.

9. Method according to claim 8, furthermore comprising providing a sensing and/or treatment element (7) adapted for sensing analytes in a body fluid in the human or animal body at the target site (2) so as to determine a physiological parameter and/or for performing treatment of the human or animal body.

10. Method for regulating tissue perfusion at a target site (2) on a human or animal body, the method comprising:
a) determining pressure exerted by a perfusion regulation device (10) on the target site (2),
b) measuring tissue perfusion at the target site (2),
c) comparing the measured tissue perfusion to a reference setpoint value, and
d) regulating pressure exerted by the perfusion regulation device (10) to the target site (2) based on a difference between the measured tissue perfusion and the reference setpoint value.

11. Method according to claim 10, furthermore comprising, before determining pressure exerted by the perfusion regulation device (10), attaching the perfusion regulation device (10) to the human or animal body at the target site (1).

12. Method according to claim 10, wherein regulating the pressure exerted by the perfusion regulation device (10) to the target site (2) is performed such that tissue perfusion at the location of the target site (2) is kept constant.

13. Method according to claim 10, wherein regulating the pressure exerted by the perfusion regulation device (10) to the target site (2) is performed such that tissue perfusion is controllably varied in time during measurement of a physiological parameter in and/or performing treatment of the human or animal body.

14. Method according to claim 10, wherein the method comprises repeating steps a) to d) at least once.

15. A controller (6) for controlled driving of a pressure regulator (4) of a perfusion regulation device (10), the controller (6) comprising a control unit (8) for controlling the pressure regulator (4) thereby using an error signal generated based on a difference between a measured tissue perfusion and a reference setpoint.
